(19) United States
(12) Patent Application Publication
(10) Pub. No.: US 2014/0209699 A1
(43) Pub. Date: Jul. 31, 2014

(54) MAN-MADE WATERFALL SYSTEM

(71) Applicant: A. Jerry Nobles, Rice, TX (US)

(72) Inventor: A. Jerry Nobles, Rice, TX (US)

(21) Appl. No.: 13/753,558

(22) Filed: Jan. 30, 2013

(51) Int. Cl. B05B 17/08

(52) U.S. Cl. CPC B05B 17/085
USPC 239/17

(57) ABSTRACT

A man-made waterfall system that includes a pond with a water receiving portion and a pair of slots, a waterfall with a front facing with a plurality of apertures and a pair of elongated rectangular inserts, the pair of elongated rectangular inserts correspond to and are removably inserted into the pair of slots disposed on the back portion of the perimeter and a back spillway that receives water that overflows from the water receiving portion of the pond. The system also includes a plurality of water pipes attached to the back spillway and a water pump that continuously pumps the water in the water pipes from the back spillway to the apertures disposed on the front facing of the waterfall.

### TECHNICAL FIELD & BACKGROUND

The present invention generally relates to a waterfall system. More specifically, the invention is a man-made waterfall system.

Typical man-made waterfall features tend to be extremely expensive to install and relatively difficult to self-assemble. Putting together a natural looking waterfall has the capacity to be significantly time consuming.

The present invention is a man-made waterfall system that is relatively easy to install and is relatively inexpensive.

### SUMMARY OF THE INVENTION

The present invention is a man-made waterfall system that is relatively easy to install and is relatively inexpensive.

It is an object of the present invention to provide a man-made waterfall system that includes three primary pieces that are snapped together in place to assemble the man-made waterfall.

It is an object of the present invention to provide a man-made waterfall system that operates without concrete, bricks, mortar or blocks.

It is an object of the present invention to provide a man-made waterfall system that is a do-it-yourself assembled man-made waterfall.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a man-made waterfall system, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

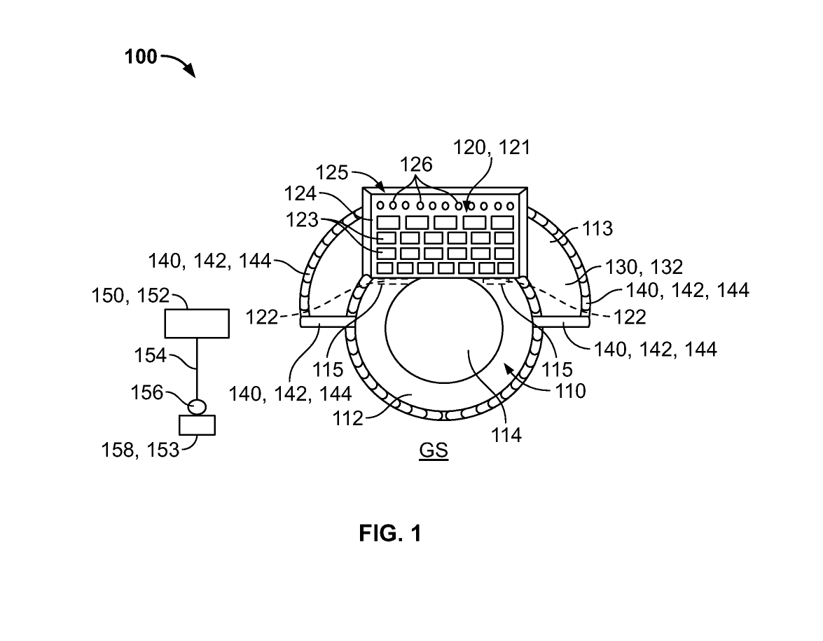

FIG. 1 illustrates a front view of a man-made waterfall system 100, according to an embodiment of the present invention.

The man-made waterfall system 100 includes a pond 110, a waterfall 120, a back spillway 130, a plurality of water pipes 140 and a water pump 150. The pond 110 has a perimeter 112 with a back portion 113 and a water receiving portion 114 with a pair of slots 115 disposed on the back portion 113 of the perimeter 112. The pond 110 is placed on a ground surface GS which can be any suitable indoor ground surface or outdoor ground surface. The waterfall 120 has a pair of elongated rectangular inserts 122 that correspond to the pair of slots 115 that are removably inserted into the pair of slots 115. The waterfall 120 is generally planar-shaped 121 with a front facing 124 with a horizontal top portion 125 with a plurality of apertures 126 disposed on the horizontal top portion 125 of the front facing 124. The waterfall 120 provides water that disperses from the apertures 126 that runs along the front facing 124 of the waterfall 120 and into the water receiving portion 114 of the pond 110 thereby simulating movement of the water in a natural waterfall. The front facing 124 of the waterfall 120 can be decorated with artificial brick 123, artificial stucco (not shown), artificial rock (not shown) or artificial stone (not shown) or any other suitable decorative surfacing. The waterfall 120 is approximately 3 feet in height but can be any suitable height and is made of plastic or other suitable material. The back spillway 130 has a general semi-circular shape 132 and receives water that overflows from the water receiving portion 114 over the back portion 113 of the perimeter 112 of the pond 110. The water pipes 140 attached to the back spillway 130 receive the water that overflows from the back spillway 130 and directs the water to the apertures 126 that run along the front facing 124 of the waterfall 120. The water pipes 140 can be made of metal, plastic or any other suitable material. The plastic water pipes 142 are without the risk of bursting from expansion during cold weather but the metal water pipes 144 have the advantage of being relatively more durable than the plastic water pipes. The water pump 150 is attached to the water pipes 140 that continuously pump the water in the water pipes 140 from the back spillway 130 to the apertures 126 that run along the front facing 124 of the waterfall 120 thereby recycling the water utilized in the man-made waterfall system 100. The water pump 150 is an electrical water pump 152 that includes an electrical cord 154 and an electrical plug 156 that is typically powered by a hardwire electrical source 158 such as an electrical outlet 153. The electrical water pump 152 can also be powered by one or more batteries of any suitable size or type (not shown) or any other suitable electrical power source.

The man-made waterfall system is an electrically powered plastic waterfall system that includes an approximate three foot tall waterfall and a pond at its base. The rear water pump disperses water through a plurality of small openings at the top of the waterfall where gravity then forces the water to cascade downward into the pond, mimicking the movement of a natural waterfall. A steady amount of water overflows from the pond into a back spill area where water is continuously pumped through the piping to the small openings of the waterfall in order to repeat the waterfall water process. The man-made waterfall system will be readily available at suitable hardware and home improvement retail stores. The man-made waterfall system can be assembled without the use of concrete, bricks, blocks or mortar, making it financially affordable to a relatively wide range of users. The man-made waterfall system is made of relatively lightweight plastic materials that make it easy for a single user to assemble the man-made waterfall system relatively quickly.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A man-made waterfall system, comprising:
a pond that includes a perimeter and a water receiving portion, the perimeter with a back portion and a pair of slots disposed on the back portion of the perimeter;
a waterfall with a bottom and a front facing, the front facing with a horizontal top portion with a plurality of apertures disposed on the horizontal top portion, the bottom of the waterfall with a pair of elongated rectangular inserts, the pair of elongated rectangular inserts correspond to and are removably inserted into the pair of slots disposed on the back portion of the perimeter;
a back spillway, the back spillway receives water that overflows from the water receiving portion over the back portion of the perimeter of the pond;
a plurality of water pipes attached to the back spillway, the water pipes receive the water that overflows from the back spillway and directs the water to the apertures disposed on the front facing of the waterfall; and
a water pump attached to the water pipes, the water pump continuously pumps the water in the water pipes from the back spillway to the apertures disposed on the front facing of the waterfall.

2. The man-made waterfall system according to claim 1, wherein the pond is placed on a ground surface.

3. The man-made waterfall system according to claim 1, wherein the waterfall is generally planar-shaped.

4. The man-made waterfall system according to claim 1, wherein the waterfall provides water that disperses from the apertures disposed on the front facing of the waterfall and into the water receiving portion of the pond.

5. The man-made waterfall system according to claim 1, wherein the front facing of the waterfall is decorated with artificial brick.

6. The man-made waterfall system according to claim 1, wherein the back spillway has a generally semi-circular shape.

7. The man-made waterfall system according to claim 1, wherein the water pipes are plastic water pipes that are without a risk of bursting from expansion during cold weather.

8. The man-made waterfall system according to claim 1, wherein the water pump recycles the water utilized in the man-made waterfall system.

9. The man-made waterfall system according to claim 1, wherein the water pump is an electrical water pump.

10. The man-made waterfall system according to claim 9, wherein the electrical water pump includes an electrical cord and an electrical plug.

11. The man-made waterfall system according to claim 9, wherein the electrical water pump is powered by a hardwire electrical source.

12. The man-made waterfall system according to claim 9, wherein the electrical water pump is powered by one or more batteries.

13. A man-made waterfall system, comprising:
a pond placed on a ground surface, the pond includes a perimeter and a water receiving portion, the perimeter with a back portion and a pair of slots disposed on the back portion of the perimeter;
a generally planar-shaped waterfall with a bottom and a front facing, the waterfall provides water that disperses from the apertures disposed on the front facing of the waterfall into the water receiving portion of the pond, the bottom of the waterfall includes a pair of elongated rectangular inserts, the pair of elongated rectangular inserts correspond to and are removably inserted into the pair of slots disposed on the back portion of the perimeter, the front facing with a horizontal top portion with a plurality of apertures disposed on the horizontal top portion;
a generally semi-circular shape back spillway, the back spillway receives water that overflows from the water receiving portion over the back portion of the perimeter of the pond;
a plurality of water pipes attached to the generally semi-circular shape back spillway, that receive the water that overflows from the back spillway and directs the water to the apertures disposed on the front facing of the waterfall; and
an electrical water pump attached to the water pipes, the water pump continuously pumps the water in the water pipes from the back spillway to the apertures disposed on the front facing of the waterfall, the water pump recycles the water utilized in the man-made waterfall system.

14. The man-made waterfall system according to claim 13, wherein the front facing of the waterfall is decorated with artificial brick.

15. The man-made waterfall system according to claim 13, wherein the water pipes are plastic water pipes that are without a risk of bursting from expansion during cold weather.

16. The man-made waterfall system according to claim 15, wherein the water pipes are metal and are more durable than the plastic water pipes.

17. The man-made waterfall system according to claim 13, wherein the waterfall is approximately 3 feet in height.

18. The man-made waterfall system according to claim 13, wherein the waterfall is made of plastic.

19. The man-made waterfall system according to claim 13, wherein the electrical water pump includes an electrical cord and an electrical plug.

20. The man-made waterfall system according to claim 13, wherein the electrical water pump is powered by a selected one of a hardwire electrical source and one or more batteries.
